(19) United States
(12) Patent Application Publication
(10) Pub. No.: US 2022/0410002 A1
(43) Pub. Date: Dec. 29, 2022

(54) MESH PROCESSING FOR VIEWABILITY TESTING

(71) Applicant: Bidstack Group PLC, London (GB)

(72) Inventors: Arvids KOKINS, London (GB); Francesco PETRUZZELLI, London (GB)

(21) Appl. No.: 17/477,049

(22) Filed: Sep. 16, 2021

Related U.S. Application Data
(60) Provisional application No. 63/216,393, filed on Jun. 29, 2021.

(51) Int. Cl. A63F 13/525; G06T 17/20; G06T 15/04; G06T 15/20; G06T 7/50; G06T 15/40

(52) U.S. Cl. CPC A63F 13/525; G06T 17/205; G06T 15/04; G06T 15/20; G06T 7/50; G06T 15/405; G06T 2210/12

(57) ABSTRACT

A computer-implemented method includes obtaining an input polygon mesh representing at least part of a three-dimensional scene and comprising a plurality of input polygons, and obtaining mapping data for mapping at least part of an image to a region of the input polygon when the three-dimensional scene is rendered. Said region extends at least partway across the plurality of input polygons. The method includes using the mapping data to generate one or more test polygons to match or approximate said region of the input polygon mesh. Each of the generated test polygons is distinct from each of said plurality of input polygons.

### BACKGROUND OF THE INVENTION

### Field of the Invention

The present disclosure relates to processing a polygon mesh representing a three-dimensional scene to generate test polygons for use in viewability testing when the three-dimensional scene is rendered from a perspective of a virtual camera. The disclosure has particular, but not exclusive, relevance to viewability testing in a video game.

### Description of the Related Technology

The popularity of video games has risen meteorically, and at the time of writing the global video game industry is worth more than the music and film industries combined. In the early years of gaming, video game developers and associated entities made money through the sale of video games on physical media (laser discs and cartridges). Nowadays, video games are more often downloaded or even streamed onto a connected gaming device such as a personal computer (PC), games console or smartphone. Whilst this model still allows commercial entities to make money from the sale of video games, it is common for further revenue streams to be pursued based on the sale of advertising space, including advertising space within the video games themselves. In the context of video games, adverts may be presented to a user as part of a loading screen or menu, or alternatively may be rendered within a computer-generated environment during gameplay, leading to the notion of in-game advertising. For example, in a sports game, advertising boards within a stadium may present adverts for real-life products. In an adventure game or first-person shooting game, adverts for real-life products may appear on billboards or other objects within the game environment.

Revenue models based on the sale of advertising space are ubiquitous in the context of film and television, as well as for websites and social media applications. Advertisers are typically charged in dependence on the expected or actual reach of a given advert, or in other words the expected or actual number of “impressions” of the advert experienced by consumers. For television and film, an advertising fee may be negotiated in dependence on a number of showings of the advert and a predicted audience size for each showing. For a website or social media application, the advertising fee may be related to a number of page views or clicks. Distribution of an advert may then be controlled in dependence on these factors.

In the above cases, it is technically straightforward to predict and measure the number of advertising impressions experienced by users. For video games, the situation is different. Because different players will experience a given video game differently depending on actions taken by the players and/or random factors within the video game code, it is not generally possible to predict a priori the extent to which a given advert within a video game will be viewed, and therefore the number of impressions experienced by the player. In order for the advertising revenue model to be applied to in-game advertising, the visibility of an advert may therefore be measured in real time as a video game is played. Determining the extent to which an advert or other object is visible during gameplay is referred to as viewability testing.

The data gathered from viewability testing may be used to determine an advertising fee or to control distribution of adverts. The data may also be used to inform the advertising entity, the game developer, or a third party, of the effectiveness of the advert. Various factors affect the degree to which an in-game advert is experienced by a player of the video game, including: the duration of time that the advert is on screen; the size of the advert in relation to the total size of the screen or viewport; the angle of the advert with respect to the axis of the virtual camera; and the proportion of an advert which is visible within the screen or viewport. The visibility of the advert depends on whether and how much the advert extends outside the viewport, and whether any portion of the advert is occluded by objects appearing in the scene with the advert.

Occlusion detection during viewability testing may be performed using ray tracing, in which algebraic ray equations are solved to determine whether rays emanating from a virtual camera reach test points distributed across an advert surface. Alternatively, occlusion detection may be performed using Z-buffer depth testing in which depth map values of test points distributed across an advert surface are compared with values stored in a Z-buffer during rendering.

In each of the occlusion detection methods mentioned above, processing resources are required to determine locations of the test points on the advert surface, and then to perform the necessary tests on a frame-by-frame basis. Modern video game environments may include detailed polygon meshes comprising large numbers of polygons, enabling highly detailed objects to be rendered and curved surfaces to be convincingly approximated. However, using such detailed polygon meshes for the purpose of viewability testing can result in an inefficient use of processing resources. For example, a fabric banner on which an advert is located may be substantially flat, but nevertheless modelled using a large number of polygons to allow for fluctuations in the surface. Such fluctuations are inconsequential to the visibility of the advert during gameplay, but would significantly increase the processing demands and complexity of determining locations of test points for a given frame, which can potentially contribute to undesirable lag.

In some cases, viewability testing based on detailed polygon meshes may provide limited insight into the viewability of an advert. For example, the viewability of an advert may depend on a viewing angle at which the advert appears with respect to a line of sight from the virtual camera. For a non-flat surface, different polygons have different viewing angles and therefore the overall viewing angle of the advert is ill-defined. A possible way to determine an overall viewing angle for the surface would be to calculate viewing angles of the individual polygons and compute an average, but this would add significantly to the complexity and processing demands of the viewability testing procedure.

### SUMMARY

According to a first aspect of the present disclosure, there is provided a computer-implemented method. The method includes obtaining an input polygon mesh representing at least part of a three-dimensional scene and comprising a plurality of input polygons, and obtaining mapping data for mapping at least part of an image to a region of the input polygon mesh when the three-dimensional scene is rendered. Said region extends at least partway across the plurality of input polygons. The method includes using the mapping data to generate one or more test polygons to match or approximate said region of the input polygon mesh. Each of the generated one or more test polygons is distinct from each of said plurality of input polygons. The resulting one or more test polygons have world coordinates substantially corresponding to a surface of an object of interest within the scene, for example a surface on which an advert, or part of an advert, is placed. Generating a distinct set of test polygons for viewability testing enables the viewability testing to be performed efficiently and accurately, and the use of mapping data to automatically generate the test polygons negates the need for a human designer to create test polygons manually.

In many cases, adverts are substantially quadrilateral in shape, or formed of substantially quadrilateral portions, whereas polygon meshes for rendering are typically formed of triangles, for which graphics processing hardware is optimized. The processing may therefore involve generating one or more test quadrilaterals (“quads”) from an input polygon mesh formed of triangles.

Generating the one or more test polygons may include generating an intermediate polygon which matches or approximates the plurality of input polygons, and generating a test quad corresponding to at least a portion of the generated intermediate polygon, dimensions of the at least portion and a location of the at least portion relative to the intermediate polygon being dependent on the mapping data. For example, where the polygon mesh includes an uneven surface comprising multiple polygons, an intermediate polygon may be generated which approximates the uneven surface. The resulting test polygons enable test points to be generated for viewability testing without the computational demands of processing a large number of polygons on a frame-by-frame basis, and enables meaningful measurements of viewing angles to be made, which may otherwise be ill-defined in the case of an uneven surface. In cases where multiple adverts appear on a single part of a polygon mesh, several test quads may be generated corresponding to respective different portions of the intermediate polygon.

A method of generating the intermediate polygon may include determining a texture coordinate bounding box for the plurality of input polygons. For each of one or more input polygons of the plurality of input polygons, the method may include determining planar coordinates of each corner of the texture coordinate bounding box with respect to the input polygon (for example, barycentric coordinates), and determining world coordinates of each corner of the texture coordinate bounding box based on the determined planar coordinates and a world space position of each vertex of the input polygon. The method may further include determining an average of the determined world coordinates of each corner of the texture coordinate bounding box, whereby to determine world coordinates of each corner of the intermediate polygon. This procedure results in an intermediate polygon which matches or approximates the at least part of the polygon mesh, from which test polygons can be generated suitable for viewability testing purposes.

The intermediate polygon may be a first intermediate polygon, and generating the one or more test polygons may include determining a plurality of mutually disconnected parts of the input polygon mesh, each determined part comprising a respective plurality of connected input polygons, and generating a plurality of intermediate polygons (including the first intermediate polygon) each depending on a respective one of the determined parts of the polygon mesh. In cases where a polygon mesh represents several objects that are not in contact with one another, it may be desirable to ensure that distinct intermediate polygons (and accordingly, distinct test polygons) are generated for the objects.

Generating the one or more test polygons may include splitting the input polygon mesh along any edge or chain of edges extending across the input polygon mesh or a disconnected part of the input polygon mesh and having an isolated substantial angle between input polygons, thereby to generate a plurality of subparts of the input polygon mesh, and generating a plurality of intermediate polygons, including the first intermediate polygon, each matching or approximating a respective one of the determined subparts of the input polygon mesh. Each of the one or more test polygons is then at least a portion of a respective intermediate polygon of the plurality of intermediate polygons. In many cases, a mesh geometry comprises a series of substantially flat surfaces connected together, for example to approximate a curved surface. By splitting the polygon mesh at edges having isolated substantial angle differences, test polygons can be generated corresponding to portions of these flat surfaces.

The method may include determining that the input polygon mesh has texture coordinates extending beyond a predetermined range (typically [0,1]), indicating a repeating pattern, and generating a plurality of test polygons corresponding to respective different instances of the repeating pattern. In this way, when texture wrapping is used to create a spatially repeating advert, a separate test polygon is created for each instance of the repeating advert.

Generating the one or more test polygons may include grouping test polygons with matching edges to generate one or more test polygon groups. In cases where an advert spans multiple test polygons, it is desirable for the viewability testing to generate data pertaining to the advert as a whole, rather than for separate portions of the advert. It is therefore advantageous for test polygons to be grouped automatically such that the results of viewability testing can be combined in a suitable manner.

The computer-implemented method may further include discarding any test polygon (or test polygon group where grouping is performed) having a size smaller than a threshold fraction of said image. According to predetermined criteria associated with the viewability testing procedure, test polygons covering less than a threshold fraction of an advert may be too small to ever generate a viewability event. Discarding such test polygons from the set avoids redundant processing during viewability testing.

The region to which at least part of the image is to be mapped may extend at least partway across each input polygon of said plurality of input polygons, and the number of generated test polygons may be less than the number of input polygons in said plurality of input polygons. By making the number of test polygons smaller than the number of processed input polygons, the viewability testing can be performed efficiently and at a relatively low computational cost without having an adverse effect on graphics performance, for example where an advert is mapped to a region of the input polygon mesh that fluctuates around a substantially flat surface.

When applied in the context of a video game, the generating of the test polygons may be performed at build time before the video game is distributed to end users, or alternatively may be performed at runtime, for example during or after when a scene is loaded for rendering. The latter case enables the method to be applied even when a polygon mesh representing a scene cannot be determined at build time, for example in the case of a procedural mesh. Accordingly, in some cases the computer-implemented method may further include rendering the three-dimensional scene from a perspective of a virtual camera using the input polygon mesh, and processing at least one of the generated one or more test polygons to determine an extent to which said at least one of the one or more test polygons is visible from the perspective of the virtual camera.

The rendering of the three-dimensional scene from the perspective of the virtual camera may include storing, in a depth buffer, depth map data corresponding to a depth map of at least part of the three-dimensional scene and comprising respective depth map values at pixel locations spanning at least part of the field of view of the virtual camera. Processing said at least one of the generated one or more test polygons may then include: generating a plurality of points distributed substantially evenly over a first test polygon of the generated one or more test polygons; determining, for each point of the plurality of points lying within said at least part of the field of view of the virtual camera, a respective pixel location and depth map value from the perspective of the virtual camera; determining whether each point of the plurality of points is visible from the perspective of the virtual camera based on a comparison between the depth map value determined for the point and a corresponding one or more of the depth map values stored in the depth buffer; and determining the extent to which the first test polygon is visible in dependence on which of the plurality of points are determined to be visible from the perspective of the virtual camera. The use of depth buffer data for viewability testing can result in improved computational efficiency compared with other methods, for example methods based on ray tracing. The method is widely compatible with video games of any genre provided that rasterization-based rendering is utilized, enabling game developers or third parties to incorporate such functionality into video games with minimum alteration to their video game code. Furthermore, the viewability testing may be at least partially implemented within a graphics processing unit (GPU) of a gaming device, for example using shader code. Utilizing the GPU for viewability testing enables the viewability testing to be performed in a highly parallelized manner whilst reducing the processing load on the CPU of the host system.

According to a second aspect, there is provided a data processing system. The data processing system is arranged to obtain an input polygon mesh representing at least part of a three-dimensional scene and comprising a plurality of input polygons, and obtain mapping data for mapping at least part of an image to a region of the input polygon mesh when the three-dimensional scene is rendered. Said region extends at least partway across the plurality of input polygons. The data processing system is arranged to use the mapping data to generate one or more test polygons to match or approximate said region of the input polygon mesh, each of the generated one or more test polygons is distinct from each of said plurality of input polygons.

According to a third aspect, there is provided a non-transient storage medium comprising machine-readable instructions which, when executed by a computer, cause the computer to obtain an input polygon mesh representing at least part of a three-dimensional scene and comprising a plurality of input polygons, and obtain mapping data for mapping at least part of an image to a region of the input polygon mesh when the three-dimensional scene is rendered. Said region extends at least partway across the plurality of input polygons. The data processing system is arranged to use the mapping data to generate one or more test polygons to match or approximate said region of the input polygon mesh, where each of the generated one or more test polygons is distinct from each of said plurality of input polygons.

Further features and advantages of the disclosure will become apparent from the following description of preferred embodiments, given by way of example only, which is made with reference to the accompanying drawings.

### BRIEF DESCRIPTION OF THE DRAWINGS

FIG. 1 schematically shows functional components of a system in accordance with examples.

FIG. 2 is a flow diagram representing a first method of processing a polygon mesh to generate a set of test quads and using the test quads for viewability testing in accordance with examples.

FIG. 3 is a flow diagram representing a second method of processing a polygon mesh to generate a set of test quads and using the test quads for viewability testing in accordance with examples.

FIG. 4 is a flow diagram representing a computer-implemented method of processing a polygon mesh to generate a set of test quads in accordance with examples.

FIG. 5 shows a first illustrative example of a polygon mesh being processed in accordance with the present disclosure.

FIG. 6 shows a second illustrative example of a polygon mesh being processed in accordance with the present disclosure.

FIG. 7 is a flow diagram representing a computer-implemented method of processing part of a polygon mesh to generate a test quad in accordance with examples.

FIG. 8 illustrates the use of test quads to perform viewability testing for a rendered three-dimensional scene.

### DETAILED DESCRIPTION OF CERTAIN INVENTIVE EMBODIMENTS

Details of systems and methods according to examples will become apparent from the following description with reference to the figures. In this description, for the purposes of explanation, numerous specific details of certain examples are set forth. Reference in the specification to ‘an example’ or similar language means that a feature, structure, or characteristic described in connection with the example is included in at least that one example but not necessarily in other examples. It should be further noted that certain examples are described schematically with certain features omitted and/or necessarily simplified for the ease of explanation and understanding of the concepts underlying the examples.

Embodiments of the present disclosure relate to processing a polygon mesh representing a three-dimensional scene to generate test polygons for use in viewability testing when the three-dimensional scene is rendered using the polygon mesh. A test polygon has world coordinates substantially corresponding to a surface of an object of interest within the scene, for example a surface on which an advert, or part of an advert, is placed, but unlike the polygons of the polygon mesh, is not intended to be used for rendering the scene. In the present disclosure, viewability testing means determining an extent to which an object (such as an advert) is visible within a scene when the scene is rendered from a perspective of a virtual camera. In particular, embodiments described herein enable more efficient viewability testing when compared with methods making direct use of the polygons used in rendering the scene.

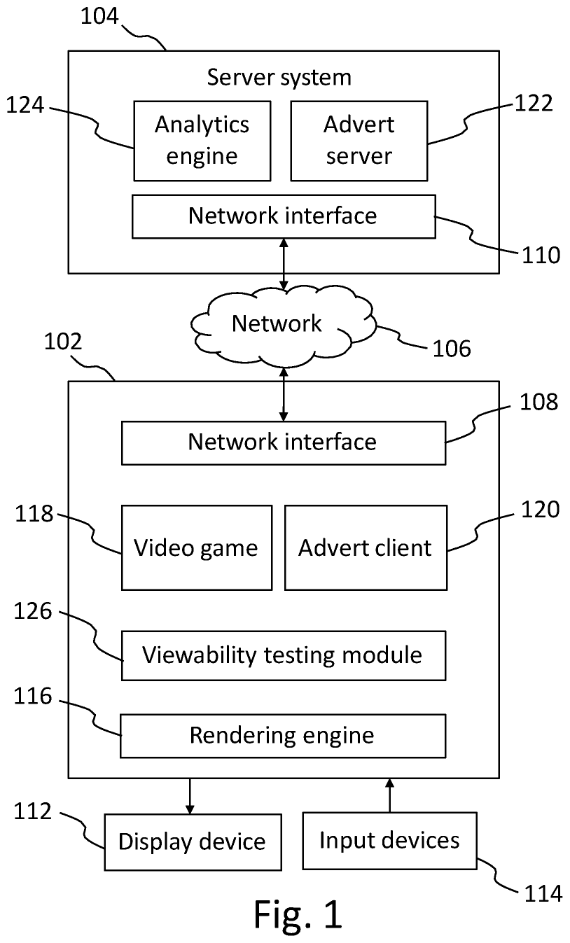

FIG. 1 schematically shows functional components of a gaming device 102 and a server system 104 arranged to communicate over a network 106 using respective network interfaces 108, 110. The various functional components shown in FIG. 1 may be implemented using software, hardware, or a combination of both. The gaming device 102 can be any electronic device capable of processing video game code to output a video signal to a display device 112 in dependence on user input received from one or more input devices 114. The video signal typically includes a computer-generated scene rendered in real time by a rendering engine 116, for example using rasterization-based rendering techniques and/or ray tracing techniques. The gaming device 102 may for example be a personal computer (PC), a laptop computer, a tablet computer, a smartphone, a games console, a smart TV, a virtual/augmented reality headset with integrated computing hardware, or a server system arranged to provide cloud-based gaming services to remote users. It will be appreciated that the gaming device 102 may include additional components not shown in FIG. 1, for example additional output devices such as audio devices and/or haptic feedback devices.

The server system 104 may be a standalone server or may be a networked system of servers, and in this example is operated by a commercial entity responsible for managing the distribution of adverts to end users (gamers) on behalf of advertisers, though in other examples an equivalent or similar system may be operated directly by an advertiser.

The gaming device 102 may be arranged to store a video game 118 locally, for example after downloading the video game 118 over the network 106, or may be arranged to read the video game 118 from a removable storage device such as an optical disc or removable flash drive. The video game 118 may be purchased by a user of the gaming device 102 from a commercial entity such as a games developer, license holder or other entity, or may be obtained for free, via a subscription model, or in accordance with any other suitable revenue model. In any of these cases, the commercial entity may obtain additional revenue by selling advertising space within the video game 118 to advertising entities, either directly or via a third party. For example, a video game developer may allocate particular objects, surfaces, or other regions of a scene within the video game 118 as advertising space, such that advertisements appear within said regions when the scene is rendered during gameplay.

The rendered advertisements may be static images or videos and may be dynamically updated as the user plays the video game 118, for example in response to certain events or certain criteria being satisfied. Furthermore, the rendered advertisements may be updated over time, for example to ensure that the rendered advertisements correspond to active advertising campaigns, and/or in dependence on licensing agreements between commercial entities. The advertisements for rendering are managed at the gaming device 102 by an advert client 120, which communicates with an advert server 122 at the server system 104. For example, the advert server 122 may transmit advert data to the advert client 120 periodically or in response to predetermined events at the gaming device 102 or the server system 104.

In addition to the advert server 122, the server system 104 includes an analytics engine 124 configured to process impression data received from the gaming device 102 and other gaming devices registered with the server system 104. The impression data may include, inter alia, information regarding how long, and to what extent, an advertisement is visible to users of the gaming devices. The impression data may include information at various levels of detail, for example a simple count of advertising impressions as determined in accordance with a given metric, or more detailed information such as how long a given advertisement is visible to a user during a session, the average on-screen size of the advertisement during that time, and the proportion of the advertisement that is visible during that time.

The analytics engine may process the impression data for a variety of purposes, for example to match a number of advertising impressions with a number agreed between the distributing party and the advertiser, to trigger the advert server 122 and/or the advert client 120 to update an advert appearing within the video game 118, or to determine an amount of compensation to be paid by the advertiser. It will be appreciated that other uses of impression data are possible, though a detailed discussion of such uses is outside the scope of the present disclosure.

In order to generate impression data for processing by the analytics engine 124, the gaming device 102 includes a viewability testing module 126. The viewability testing module 126 is responsible for determining the extent to which adverts placed within a scene are visible when the scene is rendered by the rendering engine 116 from a perspective of a virtual camera. In order to do so, the viewability testing module 126 is provided with test polygons corresponding to surfaces on which the adverts are placed, where the test polygons are typically quadrilaterals (referred to hereafter as “quads”), though other types of polygon may be used without departing from the scope of the invention. In accordance with the present disclosure, the test polygons are generated in dependence on a mesh model of the scene. As will be explained in more detail hereinafter, using such test polygons reduces the complexity and processing demands of the viewability testing process, compared with directly using the polygons of the mesh model. In cases where the mesh model is determined at build time, the test polygons may be generated in advance of the game being distributed to end users, and provided as part of the video game 118. Alternatively, if the mesh model is not determined at build time (for example in the case of a procedural mesh), the viewability testing module 126 may be arranged to generate the test polygons at runtime (for example during or after when a scene is first loaded).

It should be noted that, whilst the viewability testing module 126 is shown separately from the video game 118 in FIG. 1, the functionality of the viewability testing module 126 (including, optionally, the runtime generation of test polygons) may in fact be defined within the video game 118, for example as code written by the game developer or provided by the operator of the server system 104 to the game developer as part of a software development kit (SDK).

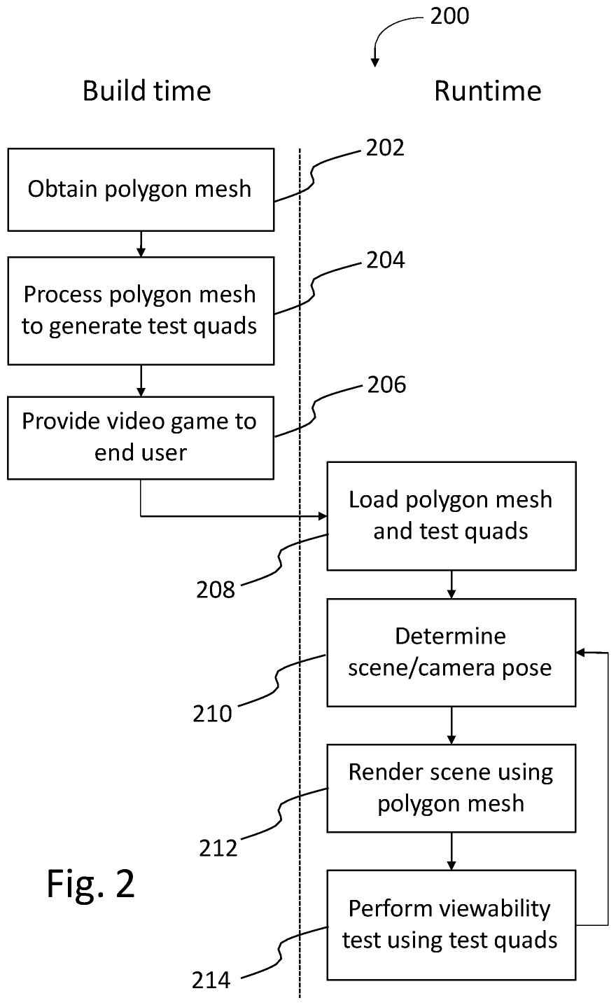

FIG. 2 shows an example of an end-to-end method 200 in which test polygons are generated and used for viewability testing within a video game in accordance with the present disclosure. The initial steps 202-204 of the method 200 are performed as part of the process of building the video game, for example on a computing device operated by the game developer or a third party responsible for managing the distribution of adverts to end users. Later steps 208-214 of the method 200 are performed at runtime on a gaming device of an end user.

The method 200 involves obtaining, at 202, a polygon mesh representing at least part of a three-dimensional scene within a video game, for use in rendering the scene. In this example, the polygon mesh is determined by the game developer at the build stage prior to the video game being distributed to end users. The polygon mesh may exclusively contain triangles, which are particularly convenient for rasterization-based rendering and for which most graphics hardware is optimized, though in some cases the polygon mesh may contain other polygons such as quads in addition to, or instead of, triangles.

The method 200 proceeds with processing, at 204, the obtained polygon mesh to generate a set of one or more test quads for use in viewability testing when the scene is rendered. The generated test quads may be distinct from the polygons of the obtained polygon mesh, reflecting the different purposes of the test polygons and the polygons used for rendering. For example, test quads may be generated in dependence on respective sets of connected polygons of the polygon mesh, where polygons are considered to be connected if they share at least one vertex, resulting in the number of test quads being less than the number of polygons from which the test quads are generated. The test quads correspond substantially to portions of surfaces on which adverts are intended to be placed in the scene. In cases where an advert covers the entirety of a set of polygons, a test quad may be generated to match or approximate the set of polygons. In cases where an advert covers only parts of the polygons in a set, a test quad may be generated as part of an intermediate polygon which matches or approximates the set of polygons. Exemplary methods of processing a polygon mesh to generate a set of test quads will be described in more detail hereinafter.

The method 200 proceeds with providing, at 206, the video game to one or more end users. The video game may be provided on a physical medium, downloaded onto gaming devices over a network, or provided by any other suitable means. The video game includes rendering data comprising mesh models for use in rendering individual scenes, along with test quads for any scenes in which adverts are expected or intended to be placed. It is noted that the test quads are not provided for use in rendering, but to enable efficient viewability testing when the scenes are rendered using the unprocessed mesh models.

At runtime, the gaming device loads, at 208, one or more polygon meshes representing a scene into memory, along with test quads corresponding to any adverts appear in the scene. On a scene-by-scene basis, the gaming device determines, at 210, a pose of a virtual camera along with various aspects of the scene prior to rendering (such as aspects which may vary dynamically between frames). The gaming device renders, at 212, the scene from the perspective of the virtual camera. Typically, the rendering is based on a graphics pipeline including an application stage, a geometry stage, and a rasterization stage, though alternative graphics pipelines are possible, for example incorporating ray tracing for at least some aspects of the scene. During the application stage, a set of rendering primitives is obtained for a set of models forming the scene. The rendering primitives generally include points, lines, and polygon meshes which collectively represent objects.

During the geometry stage, coordinates of the rendering primitives are transformed from “model” space to “world” space to “view space” to “clip” space, in dependence on a position and orientation (pose) of the models in the scene, and a pose of the virtual camera. Some primitives may be discarded or clipped, for example primitives falling completely or partially outside the field of view of the virtual camera or outside a predetermined guard band extending beyond the field of view of the virtual camera, along with optionally any facing away from the virtual camera, after which the coordinates of surviving primitives are scaled to “normalized device coordinates (NDC)” such that the NDC values for primitives (or portions of primitives) to be displayed within the viewport fall within a predetermined range (usually [−1;1]). Furthermore, depth bias may be introduced to certain polygons to ensure that coplanar polygons (for example representing a surface and a shadow on the surface) are rendered correctly and independently of the rendering order. The resulting output is then scaled to match the size of the viewport in which the scene is to be rendered. The viewport may correspond to the entire display of a display device, or may correspond to only a portion of a display device for example in the case of split-screen multiplayer, a viewport presented within a decorated frame, or a virtual screen within the computer-generated scene.

During the rasterization stage, discrete fragments are determined from the rendering primitives, where the size and position of each fragment corresponds to a respective pixel of a frame buffer/viewport. A depth buffer is used for determining which fragments are to be written as pixels to the frame buffer, and at least the fragments to be written to the frame buffer are colored using texture mapping techniques in accordance with pixel shader code. To avoid redundant processing, some video games use a separate initial rendering pass that writes only to the depth buffer, then perform further rasterization steps in a subsequent rendering pass, filtered by the populated depth buffer. Lighting effects may also be applied to the fragments, and further rendering steps such as alpha testing and antialiasing may be applied before the fragments are written to the frame buffer and screen thereafter.

Returning to the method 200, the gaming device performs, at 214, viewability testing for the frame rendered at 212, using test quads loaded at 208. The viewability testing may include occlusion detection based for example on ray tracing or Z-buffer depth testing. An example of an occlusion detection method based on Z-buffer depth testing involves generating a set of points distributed substantially evenly across a surface of each test quad, for each of the generated points lying within a field of view of the virtual camera, determining a respective depth map value from the perspective of the virtual camera. A comparison is then performed between the depth map value for the point and a corresponding one or more of the depth map values stored in the Z-buffer, to determine whether the point is visible from the perspective of the virtual camera. An extent to which the test quad is visible is then determined in dependence on which of the plurality of points are determined to be visible from the perspective of the virtual camera.

The extent to which a test quad is visible from the perspective of the virtual camera may refer to a proportion of the test quad that is visible, which may be computed either by (i) dividing the number of visible points on the test quad by the total number of points on the test quad, or (ii) dividing the number of visible points on the test quad by the number of points within the field of view of the virtual camera and multiplying the result by the proportion of the area of the test quad lying within the field of view of the virtual camera. Alternatively, the extent to which the test quad is visible may refer to a proportion of the viewport taken up by the test quad. If the number of points is proportional to the on-screen size of the test quad, then the proportion of the viewport taken up by the object may be calculated by dividing the number of visible points by the number of points which would fit on a surface covering the entire viewport. Alternatively, the proportion of the viewport taken up by the test quad may be determined by dividing the number of visible points by the number of points within the field of view of the virtual camera and multiplying the result by the projected area of the test quad in NDC space divided by the total area of the field of view in NDC space (which is 4, assuming NDC space is normalized to [−1,1]).

Evaluations of either of the metrics described above may be used to generate impression data or other summary data, for example to be transferred to a remote server system as described above with reference to FIG. 1. Other metrics may additionally be evaluated during viewability testing, such as the viewing angle of a test quad from the perspective of the virtual camera. The viewing angle may be defined as an angle between a line of sight between the virtual camera and a central point on the test quad, and a vector facing normally towards the outward-facing plane of the test quad. A viewing angle of zero indicates that the plane of the test quad is normal to the line of sight, whereas a viewing angle close to 90 degrees indicates that the plane of the test quad is nearly parallel to the line of sight, and may therefore generate no meaningful impression on the user. A viewing angle of greater than 90 degrees indicates that the test quad is facing away from the virtual camera, and the corresponding advert (or advert portion) may not be visible from the perspective of the virtual camera.

Following the rendering of a frame at 212 and the viewability testing at 214, the method 200 returns to 210 to update the pose of the virtual camera along with any dynamic aspects of the scene. The steps 210-214 are performed repeatedly on a frame-by-frame basis while the video game is played, thereby generating near real-time viewability data for the adverts appearing within the video game environment. In other examples, viewability testing may be performed at a lower frequency than the rendering of frames.

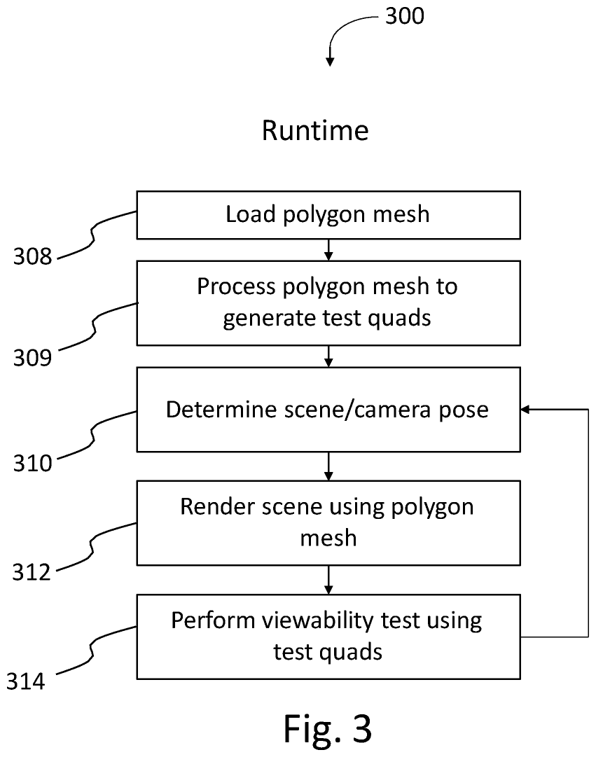

In the example of FIG. 2, the mesh models representing scenes within the video game are determined at build time, and it is therefore possible to generate sets of test quads prior to distribution of the video game to end users. In some cases, however, the mesh models are not determined at build time. Examples include procedural meshes in which the mesh model is generated at runtime in dependence on provided code. FIG. 3 shows a method 300 performed by a gaming device at runtime. The method 300 differs from the method 200 of FIG. 2 in that the processing of the polygon mesh at 309 to generate test quads is performed at runtime after the loading of the polygon mesh, rather than at build time. In this way, the method 300 is suitable for cases in which the polygon mesh is not determined until runtime.

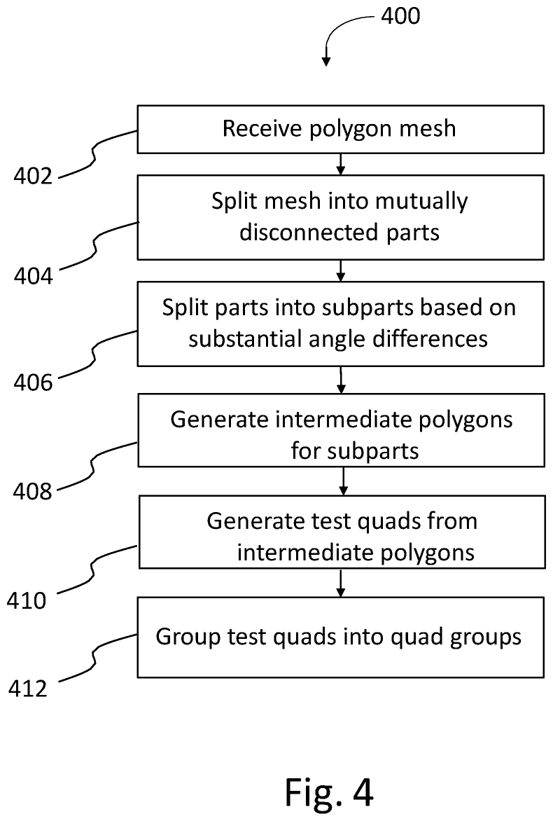

FIG. 4 shows an example of a computer-implemented method 400 for generating a set of test quads for viewability testing in accordance with examples. The method 400 includes receiving, at 402, a polygon mesh comprising a plurality of polygons for use in rendering a scene within a video game. The polygon mesh may correspond to a portion of the scene, for example a portion in which one or more adverts are to be placed.

The method 400 proceeds by determining, at 404, mutually disconnected parts of the polygon mesh. Each part includes a set of polygons directly or indirectly connected to one another, where polygons are deemed to be connected if they share at least one vertex. For a polygon mesh representing several objects that are not in contact with one another, the step of determining mutually disconnected parts of the polygon involves generating a separate mesh part for each object. In cases where all of the polygons of the polygon mesh are directly or indirectly connected to one another, the polygon mesh consists of a single mesh part and the processing at 404 can be omitted. An example of an algorithm determining parts of a polygon mesh is given below (written in pseudocode, which is to be understood to be illustrative and not prescriptive). The algorithm determines parts of the polygon mesh by iteratively generating new parts, starting from no generated parts, and merging the generated parts whenever a polygon from one part is determined to be connected to a polygon from another part:
for each polygon j in the polygon mesh:
   maintain a mesh part reference “j added to”, initialized to <none>
   for each generated part:
      if the polygon j is connected to the part:
         if “j added to” is not <none>:
         update the mesh part reference “k added to” for polygons k in the current part to match “j added to”
         remove the current part
         otherwise:
         set “j added to” to the current part
   if “j added to” is <none>:
      generate a new part and set “j added to” to the new part

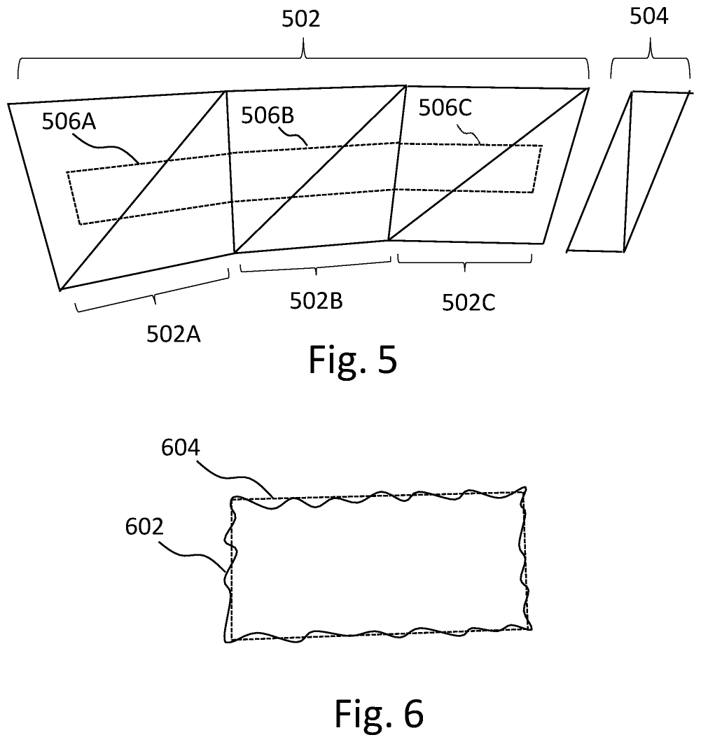

FIG. 5 shows an example of a polygon mesh consisting of eight triangles (shown using solid lines). In this example, two mesh parts 502 and 504 are determined, with the first mesh part comprising the leftmost six triangles and the second part comprising the rightmost two triangles.

The method 400 proceeds by splitting, at 406, any part of the polygon mesh that includes an edge between a pair of connected polygons, or a contiguous chain of edges between respective pairs of connected polygons, which extends across said part of the polygon mesh and has an isolated substantial angle. In the present disclosure, an edge is defined as a straight line connecting two vertices. An edge or chain of edges is said to extend across a mesh part if the extrema of the edge or chain are at respective sides of the mesh part, such that the edge or chain connects the respective sides of the mesh part. As a result, one or more of the parts determined at 404 may be split into several subparts. A shared edge between two connected polygons is said to have a substantial angle if the angle between the planes of the two connected polygons is greater than a predetermined threshold value. The threshold value may be set to zero or to a small value greater than zero to account for small errors caused by limited precision computing, which may otherwise result in a substantial angle being erroneously detected. An edge having a substantial angle is said to have an isolated substantial angle if none of its neighboring edges have a substantial angle. Neighboring edges may be defined as edges which both belong to a common polygon, though other definitions are possible, for example further requiring that the edges share a vertex with one another.

The splitting at 406 ensures that for a mesh part comprising several substantially flat sections, a separate subpart will be generated for each substantially flat section. It is common for such geometries to appear in video game environments, for example where a curved surface is approximated by a series of flat sections. In the example of FIG. 5, the part 502 is split into three subparts 502A, 502B, 502C.

An example of an algorithm for splitting a part of a polygon mesh is given below (understood to be illustrative and not prescriptive):
generate polygon adjacency data indicating, for each edge of each polygon, which polygon the edge is shared with
determine polygon normals (normalized cross product of two edges of the polygon, taken consistently so that the normals consistently indicate which sides of the polygons are forward-facing)
determine edge angles (these can be stored directly as angles or indirectly for example as the dot product of the determined normals between polygons sharing the edge, which are equal to the cosines of the angles)
generate edge splits for edges having an isolated substantial angle
flood-fill the polygons into new subparts, each subpart containing a set of polygons connected to one another by unsplit edges

In the present disclosure, “flood-fill” refers to any algorithm for determining and labelling a set of mutually connected nodes. Well-known examples of algorithms that may be used for this purpose include stack-based recursive flood-fill algorithms, graph algorithms in which nodes are pushed onto a node stack or a node queue for consumption, and other connected-component labelling (CCL) algorithms.

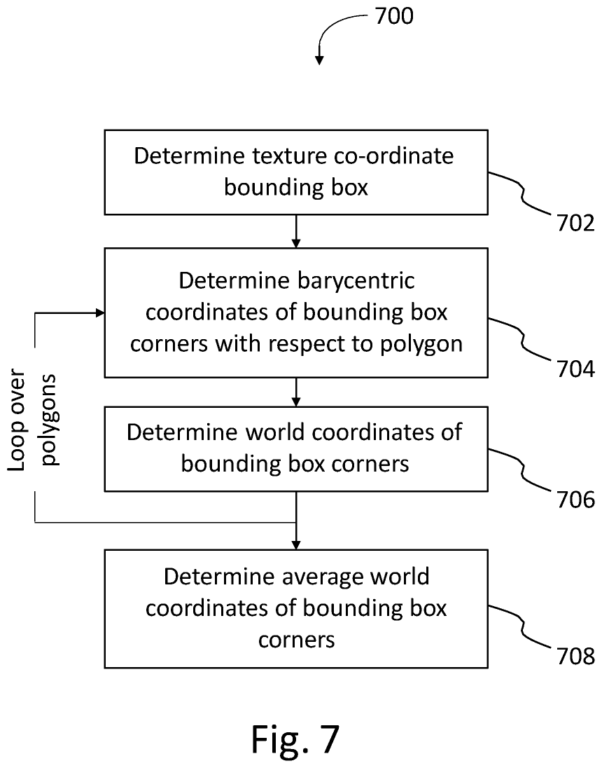

The method 400 continues by generating, at 408, an intermediate quad for each determined part of the polygon mesh (or each subpart if splitting took place at 406). Each intermediate quad matches or approximates a set of connected polygons of the polygon mesh. The position, orientation and dimensions of the intermediate quad generally depends on the orientations and positions of the polygons forming the mesh part, as well as the texture mapping used to apply adverts and other decoration to the mesh part. The intermediate quad substantially corresponds to a region of texture space covered by the mesh part. In cases where a mesh part or subpart does not correspond to an axis-aligned rectangular region of texture space, the intermediate quad may extend beyond the outer edges of polygons forming the mesh part. The intermediate quads may be generated using an averaging process based on at least some of the polygons of the mesh part or subpart, for example as described below with reference to FIG. 7, though it will be appreciated that other methods could be used without departing from the scope of the invention. Although in the present example intermediate quads are generated, in other examples other intermediate polygons may be generated, such as triangles or higher order polygons. The type of intermediate polygon may for example be made dependent on the shape of a region of texture space covered by the mesh part or subpart.

In the example of FIG. 5, four intermediate quads are generated corresponding to the subparts 502A, 502B, 502C and the unsplit mesh part 504. In the example of FIG. 6, a single intermediate quad 604 is generated, corresponding to the mesh part 602. The mesh part 602 is substantially rectangular, but is non-flat, having an uneven surface to represent a fabric banner on which an advert is to be placed. The position and dimensions of the intermediate quad 604 depend on the positions, dimensions and orientations of a set of triangles forming the mesh part 602, or equivalently on the vertex positions of the set of triangles, in such a way that the intermediate quad approximates the set of triangles forming the mesh part 602. The geometry, position and orientation of the intermediate quad 604 thereby corresponds to the substantially rectangular plane that the triangles of the mesh part 602 deviate around.

The method 400 proceeds with generating, at 410, test quads from the intermediate quads determined at 408. Each test quad is formed as a part (or whole) of a corresponding intermediate quad, and thereby corresponds to a particular region of a texture to be applied to the corresponding mesh part or subpart, for example a region corresponding to an advert (possibly clipped if the advert covers multiple subparts). In cases where an advert covers an entire mesh part and an intermediate quad matches the mesh part, the test quad may be identical to the intermediate quad. In cases where an advert does not cover the entirety of a mesh part, or where a mesh part does not match an intermediate quad, a test quad may cover only a portion of the intermediate quad. In order to determine which mesh part or subpart is covered by the advert, mapping data is provided, including for example the texture coordinates of the advert, from which the position and dimensions of the test quad can be interpolated from the vertex positions of the intermediate quad. Texture coordinates define how an image (or portion of an image) is mapped to a geometry during rendering, and typically include u and v coordinates which are orthogonal in two-dimensional texture space, and optionally w and q coordinates to enable additional texture mapping functionality. Nevertheless, other types of mapping data may be used to specify where adverts are located, for example indicating that an advert covers the entirety of a specified mesh part, or by defining offsets, rotations, scalings and the like. In any case, the information conveyed by the mapping data is resolvable to a two-dimensional texture mapping (equivalent to each vertex having UV co-ordinates), which corresponds to the texture mapping used for rendering (up to data/calculation precision limits).

In some examples, a single mesh part may include multiple adverts (or parts of adverts) corresponding to multiple regions of the texture, or multiple instances of a repeating advert. Accordingly, a given intermediate quad may result in several test quads being generated. In other examples, a mesh part may include no adverts, resulting in no test quads being generated. In the example of FIG. 5, a single advert is placed across the three subparts 502A, 502B, 502C, covering only a portion of each subpart. Accordingly, three test quads 506A, 506B, 506C are generated (represented by dashed lines), each covering a portion of a respective subpart 502A, 502B, 502C.

In some cases, a mesh part may have texture coordinates extending beyond a default maximum range (usually [0;1]). When such a mesh part is rendered, the texture may repeat in accordance with a specified texture wrapping mode, enabling adverts which repeat in one or both directions (as is often seen, for example, on advertising boards around a stadium at a sporting event). For viewability testing purposes, it is desirable to generate a single test quad for each instance of the repeating advert. Instances of a repeating advert extending beyond an edge of the mesh part may be clipped, in which case the corresponding test quads should also be clipped. An example of a method for generating a set of test quads corresponding to instances of one or more specified texture rectangles is given below (understood to be illustrative and not prescriptive):
round the texture coordinate bounding box for the intermediate quad outwards (apply floor function to the minimum values of the UV coordinates and the ceiling function to the maximum values of the UV coordinates)
for each cell (1×1) of the rounded texture coordinate bounding box:
   for each specified texture rectangle
      offset the coordinates of the texture rectangle by integer values to move the texture rectangle into the cell
      clip the texture rectangle against the original texture coordinate bounding box for the intermediate quad
         if there is no overlap between the texture rectangle and the cell, ignore the current combination of cell and texture rectangle
      bilinearly interpolate the world coordinates of the intermediate quad's vertices to generate a test quad corresponding to the texture rectangle (the interpolation factors being determined by reverse interpolating the clipped texture rectangle against the intermediate quad's texture coordinate bounding box).
      calculate normalized texture coordinates for the test quad's vertices by reverse interpolating the clipped texture rectangle (moved back to the [0;1] cell), against the original texture rectangle.

Note that, in the present disclosure, “interpolate” refers to the linear interpolation function lerp(a, b, t)=a+(b−a)*t, and “reverse interpolate” refers to the inverse operation invlerp (a, b, v)=(v−a)/(b−a). For the algorithm above, the texture rectangles are assumed to be aligned with the texture coordinate axes, though in other examples this may not be the case.

The final step of the above algorithm is optional, but may be useful for two purposes. Firstly, for viewability testing, it may be important to know what fraction of an advert is covered by a given test polygon. A test quad (or group of test quads as discussed below) covering less than a predetermined fraction of an advert (for example, ½) may never generate a viewability event or impression, and may therefore be discarded from the set of test quads. The fraction of the texture rectangle covered by the test quad is given by the area enclosed by the normalized texture coordinates of the test quad's vertices (or equivalently by dividing the area of the clipped texture rectangle by the area of the original texture rectangle corresponding to the advert). Secondly, the determined normalized texture coordinates may be used for the purpose of grouping test quads, as discussed below.

The method 400 concludes with an optional step of grouping, at 412, test quads having matching edges into test quad groups. In some examples, a single advert may span multiple test quads, and in such cases, it is desirable for the viewability testing to generate data pertaining to the advert as a whole, rather than for respective portions of the advert. It is therefore advantageous for test quads to be grouped automatically to facilitate this functionality. An example of an algorithm for connecting test quads to generate test quad groups is given below (understood to be illustrative and not prescriptive):
for each test quad qA:
   for each corner cA:
      for each matching corner cB of another test quad qB:
         check corners forward and backward for both test quads (i.e. in opposite directions around the test quads)
         if there are two corner matches total:
         add a bidirectional link between qA and qB, connecting the quads
flood-fill the connected test quads to form test quad groups

This algorithm results in groups of test quad groups connected along matching edges. Corners are considered to match if their normalized texture coordinates (as calculated above) match and their world coordinates match within a predetermined tolerance (where the tolerance may be introduced to avoid errors caused by limited precision computation). In some examples, bidirectional links are not generated at edges corresponding to minimum/maximum values of the texture coordinates (typically 0 and 1), because such edges typically represent boundaries between separate adverts or between instances of a repeating advert, in which cases it is desirable for separate test quad groups to be generated. In order to avoid erroneous connecting of test quads corresponding to different adverts, the test quads may be labelled according to which advert they correspond to. Alternatively, the entire method of generating and connecting test quads may be run separately for different adverts.

Due to the implicit nested loop over test quads qA and qB needed to identify matching corners cA and cB, the above algorithm results in a computational cost proportional to the square of the number of test quads, which can be very high when a large number of test quads is generated. In order to mitigate this issue, acceleration methods can be utilized such as sweep-and-prune (also known as sort-and-sweep). In a particular example, a separate data structure is generated for each of the three coordinate axes, into which the test quad corners are sorted in order of the respective coordinate values. To find matching corners cB for a given corner cA, a binary search is performed on each axis for upper and lower bounds of a tolerated range, yielding three lists of results containing possibly different numbers of entries. Each corner appearing in the shortest list of results (or one of the shortest lists of results if there is no unique shortest list of results) is then compared with the given corner cA to determine whether that corner is a matching corner. Corners identified as matching are assessed to determine whether they are part of a matching edge.

Although in the present example it is assumed that test quads of a given test quad group are generated from a single polygon mesh (namely, the polygon mesh received at 402), in other cases a scene may be composed of several meshes, each of which is transformed by a respective mesh matrix to give the correct position, orientation and scale in the scene. In cases where an advert spans multiple meshes, the method 400 may be augmented to include transforming the separate meshes by the corresponding mesh matrices such that positions and orientations of the resulting test quads reflect the relative positions and orientations of the meshes within the scene, ensuring that the appropriate test quad groups are still generated.

As mentioned above, certain test quad groups (or individual test quads) generated using the above method may be too small to generate viewability events during viewability testing, according to predetermined criteria. An example of such a criterion is that the total fraction of an advert covered by a quad group is less than a predetermined threshold, for example ½, which would result in <50% of the advert being visible from the test quad group at all times. Such test quad groups may be discarded to avoid redundant processing being performed at the viewability testing stage.

FIG. 7 shows an example of a computer-implemented method 700 of generating an intermediate quad to match or approximate part of a polygon mesh (or an entire polygon mesh), for example a part of a polygon mesh on which an advert or part of an advert is to be placed. The part of the polygon mesh may include a set of connected triangles, though may include other types of polygons such as quads or higher order polygons in addition to, or instead of, triangles. The method 700 proceeds with determining, at 702, a texture coordinate bounding box for the part of the polygon mesh. The texture coordinate bounding box may be a rectangle in UV space with borders corresponding to the minimum and maximum values of the UV coordinates for the part of the polygon mesh. In other examples, the texture coordinate bounding box may have a non-rectangular shape such as an irregular quadrilateral or another type of regular or irregular polygon, for example where a texture for a given mesh part adverts covers a non-rectangular region of UV space. Furthermore, the following steps may be adapted to generate a non-quadrilateral intermediate polygon, but we focus here on the case of a rectangular texture coordinate bounding box and intermediate quad for clarity.

For each polygon of the relevant part of the polygon mesh (or for a subset comprising one or more polygons of the relevant part of the polygon mesh), the method 700 proceeds with determining, at 704, planar coordinates of each corner of the texture coordinate bounding box with respect to the polygon. This generally involves converting the cartesian UV coordinates of the bounding box corners to a coordinate system in which coordinates are specified with respect to fixed points on the polygon. For example, if the polygon is a triangle, then the planar coordinates may be barycentric coordinates. If the polygon is a quadrilateral or a higher order polygon, then the polygon may be triangulated and barycentric coordinates determined for each resultant triangle. Other types of planar coordinate systems may be used, for example a non-orthogonal coordinate system with axes aligned with diagonals of a quad.

For each polygon of the relevant part of the polygon mesh, the method 700 proceeds with determining, at 706, world coordinates of each corner of the texture coordinate bounding box, based on the determined planar coordinates of the texture coordinate bounding box and a world space positions of the vertices of the polygon. For example, if the planar coordinates are barycentric coordinates, then the world space coordinates can be determined by interpolating between the world space coordinates of the triangle vertices.

The processing at 704 and 706 may be performed for each polygon of the relevant part of the polygon mesh, or for a subset of the polygons of the mesh part (such as a predetermined subset or a randomly sampled subset). For each such polygon, the world space coordinates determined at 706 define vertices of an intermediate quad which is coplanar with the polygon (assuming the polygon is planar), and in the case of a flat mesh part, may correspond to the desired test quad. However, for a non-flat mesh part, different polygons will result in different intermediate quads, at least some of which will not be coplanar with one another. The desired intermediate quad is generated by determining, at 708, an average of the determined world coordinates for each corner of the texture coordinate bounding box. The average world coordinates determined for each corner of the texture coordinate bounding box determine world coordinates of a corresponding corner of the test quad. The average may be a simple average or may be a weighted average, for example where the weightings depend on the relative sizes of the polygons.

The method of FIG. 7 results in an intermediate quad being generated which matches or approximates the relevant mesh part or subpart. In particular, the intermediate quad may match a mesh part if the mesh part is quad-shaped and flat, with sides of the mesh part having UV coordinates aligned with the UV axes.

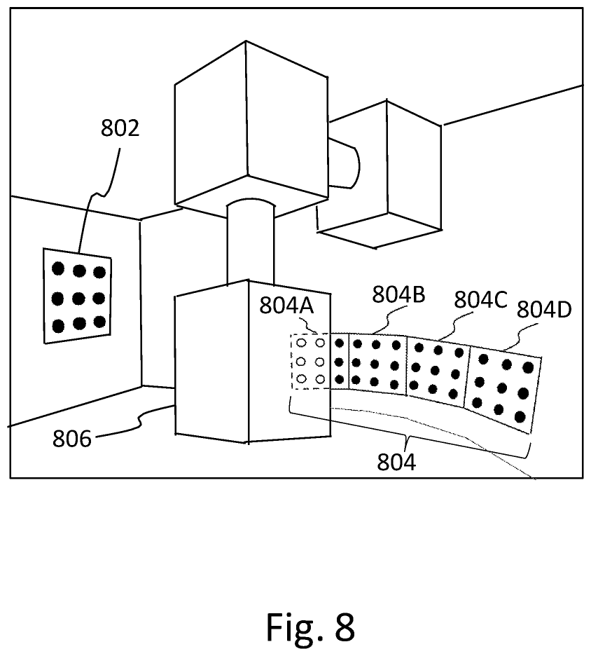

FIG. 8 shows an example of a scene in a video game in which two adverts appear. The first advert appears on a flat surface and corresponds to a single test quad 802 generated in accordance with the methods described herein. The second advert spans a series of connected flat surfaces, and corresponds to a test quad group 804 formed of four test quads 804A, 804B, 804C, 804D. The test 804A is only partially visible from the perspective of the virtual camera, because part of the test quad 804A is occluded by an object 806 (the occluded part of the test quad 804A is shown using dashed lines, but does not appear in the rendering of the scene). During viewability testing, a respective set of points is generated for each of the test quads 802, 804A, 804B, 804C 804D. The points (represented by filled and empty circles) are uniformly distributed across the test quads 802, 804A, 804B, 804C 804D. In this example, thirty of the thirty-six points generated across the test quad group 804 (represented by filled circles) are determined to be visible from the perspective of the virtual camera, whereas six of the generated points (represented by unfilled circles) are occluded by the object 806 and are determined not to be visible from the perspective of the virtual camera. The proportion of the advert corresponding to the test quad group 804 that is visible from the perspective of the virtual camera is therefore determined to be 30/36≈83%. All of the nine points generated across the test quad 802 are determined to be visible from the perspective of the virtual camera, and therefore 100% of the advert corresponding to the test quad 802 is determined to be visible from the perspective of the virtual camera.

The above embodiments are to be understood as illustrative examples. Further embodiments are envisaged. For example, although the above examples have discussed the generation of test quads, the methods discussed herein could be used to generate other types of test polygon, for example to cater for situations in which adverts are not adequately modelled using quadrilaterals. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A computer-implemented method comprising:
obtaining an input polygon mesh representing at least part of a three-dimensional scene and comprising a plurality of input polygons;
obtaining mapping data for mapping at least part of an image to a region of the input polygon mesh when the three-dimensional scene is rendered, said region extending at least partway across said plurality of input polygons; and
using the mapping data to generate one or more test polygons to match or approximate said region of the input polygon mesh,
wherein each of the generated one or more test polygons is distinct from each of said plurality of input polygons.

2. The computer-implemented method of claim 1, wherein:
the plurality of input polygons comprises a plurality of triangles; and
the generated one or more test polygons comprises one or more quadrilaterals.

3. The computer-implemented method of claim 1, wherein generating the one or more test polygons comprises:
generating an intermediate polygon which matches or approximates the plurality of input polygons; and
generating a test polygon corresponding to at least a portion of the generated intermediate polygon,
wherein dimensions of the at least portion and/or a location of the at least portion relative to the intermediate polygon are dependent on the mapping data.

4. The computer-implemented method of claim 3, wherein:
the mapping data indicates a plurality of regions of the input polygon mesh to which respective images are to be mapped; and
using the mapping data comprises generating a plurality of test quads corresponding to respective different regions of the input polygon mesh indicated by the mapping data and being respective different portions of the generated intermediate polygon.

5. The computer-implemented method of claim 3, wherein generating the intermediate polygon comprises:
determining a texture coordinate bounding box for the plurality of input polygons;
for each of one or more input polygons of the plurality of input polygons:
determining planar coordinates of each corner of the texture coordinate bounding box with respect to the input polygon; and
determining world coordinates of each corner of the texture coordinate bounding box based on the determined planar coordinates and a world space position of each vertex of the input polygon; and
determining an average of the determined world coordinates of each corner of the texture coordinate bounding box, whereby to determine world coordinates of each corner of the intermediate polygon.

6. The computer-implemented method of claim 3, wherein the intermediate polygon is a first intermediate polygon, and generating the one or more test polygons comprises:
determining a plurality of mutually disconnected parts of the input polygon mesh, each determined part comprising a respective plurality of connected input polygons; and
generating a plurality of intermediate polygons, including the first intermediate polygon, each depending on a respective one of the determined parts of the polygon mesh,
wherein each of the one or more test polygons is at least a portion of a respective intermediate polygon of the plurality of intermediate polygons.

7. The computer-implemented method of claim 6, further comprising splitting one or more of the determined parts of the input polygon mesh along any edge or chain of edges extending across one of the determined parts and having an isolated substantial angle between input polygons, thereby to determine a plurality of subparts of the input polygon mesh,
wherein each of the generated plurality of intermediate polygons matches or approximates a respective one of the determined plurality of subparts.

8. The computer-implemented method of claim 3, wherein the intermediate polygon is a first intermediate polygon, and generating the one or more test polygons comprises:
splitting the input polygon mesh along any edge or chain of edges extending across the input polygon mesh and having an isolated substantial angle between polygons, thereby to determine a plurality of subparts of the input polygon mesh; and
generating a plurality of intermediate polygons, including the first intermediate polygon, each matching or approximating a respective one of the determined subparts of the input polygon mesh,
wherein each of the one or more test polygons is at least a portion of a respective intermediate polygon of the plurality of intermediate polygons.

9. The computer-implemented method of claim 1, comprising:
determining that the input polygon mesh has texture coordinates extending beyond a predetermined range, indicating a repeating pattern; and
generating a plurality of test polygons corresponding to respective different instances of the repeating pattern.

10. The computer-implemented method of claim 1, further comprising discarding any test polygon smaller than a threshold fraction of said image.

11. The computer-implemented method of claim 1, further comprising grouping test polygons with matching edges to generate one or more test polygon groups.

12. The computer-implemented method of claim 11, further comprising discarding any test polygon group smaller than a threshold fraction of said image.

13. The computer-implemented method of claim 1, wherein:
said region extends at least partway across each input polygon of said plurality of input polygons; and
the number of generated test polygons is less than the number of input polygons in said plurality of input polygons.

14. The computer-implemented method of claim 1, further comprising:
rendering the three-dimensional scene from a perspective of a virtual camera using the input polygon mesh; and
processing at least one of the generated one or more test polygons to determine an extent to which said at least one of the generated one or more test polygons is visible from the perspective of the virtual camera.

15. The computer-implemented method of claim 14, wherein:
rendering the three-dimensional scene from the perspective of the virtual camera comprises storing, in a depth buffer, depth map data corresponding to a depth map of at least part of the three-dimensional scene and comprising respective depth map values at pixel locations spanning at least part of a field of view of the virtual camera; and
processing said at least one of the generated one or more test polygons comprises:
generating a plurality of points distributed substantially evenly across a first test polygon of the generated one or more test polygons;
for each point of the generated plurality of points lying within said at least part of the field of view of the virtual camera:
determining a respective depth map value from the perspective of the virtual camera; and
determining, using the depth map data stored in the depth buffer, whether the point is visible from the perspective of the virtual camera based on a comparison between the determined depth map value for the point and a corresponding one or more of the depth map values stored in the depth buffer; and
determining an extent to which the first test polygon is visible in dependence on which of the plurality of points are determined to be visible from the perspective of the virtual camera.

16. The computer-implemented method of claim 1, performed during or after loading of the three-dimensional scene into memory for rendering.

17. A data processing system arranged to:
obtain an input polygon mesh representing at least part of a three-dimensional scene and comprising a plurality of input polygons;
obtain mapping data for mapping at least part of an image to a region of the input polygon mesh when the three-dimensional scene is rendered, said region extending at least partway across the plurality of input polygons; and
using the mapping data to generate one or more test polygons to match or approximate said region of the input polygon mesh,
wherein each of the generated one or more test polygons is distinct from each of said plurality of input polygons.

18. The data processing system of claim 17, wherein:
the plurality of input polygons comprises a plurality of triangles; and
the generated one or more of test polygons comprises one or more quadrilaterals.

19. The data processing system of claim 17, comprising:
a rendering engine for rendering the three-dimensional scene from a perspective of a virtual camera using the input polygon mesh; and
a viewability testing module for processing at least one of the generated one or more test polygons to determine an extent to which said at least one of the one or more test polygons is visible from the perspective of the virtual camera.

20. A non-transient storage medium comprising machine-readable instructions which, when executed by a computer, cause the computer to:
obtain an input polygon mesh representing at least part of a three-dimensional scene and comprising a plurality of input polygons;
obtain mapping data for mapping at least part of an image to a region of the input polygon mesh when the three-dimensional scene is rendered, said region extending at least partway across the plurality of input polygons; and
using the mapping data to generate one or more test polygons to match or approximate said region of the input polygon mesh,
wherein each of the generated one or more test polygons is distinct from each of said plurality of input polygons.
